(19) United States
(12) Patent Application Publication
(10) Pub. No.: US 2014/0223576 A1
(43) Pub. Date: Aug. 7, 2014

(54) Method and System for Improving the Data Security of Cloud Computing

(71) Applicant: Beijing Z & W Technology Consulting Co., Ltd., Beijing (CN)

(72) Inventor: Naiyan Zhao, Beijing (CN)

(21) Appl. No.: 14/129,980

(22) PCT Filed: Sep. 24, 2013
(86) PCT No.: PCT/CN2013/084135

§ 371 Date: Dec. 29, 2013

(30) Foreign Application Priority Data
Oct. 17, 2012 (CN) 201210393824.0

(51) Int. Cl. H04L 29/06

(52) U.S. Cl. CPC H04L 63/10
USPC 726/27

(57) ABSTRACT

A method and system for improving the data security of cloud computing comprising: users establishing an index information table for physical LUN devices available to cloud computing service instances, and setting mapping rules of virtual LBA address space for virtual LUN devices and physical LBA address space for data storage according to the index information table; according to the mapping rules, users establishing and saving a mapping relationship between virtual LBA address space and physical LBA address space for data storage; according to the mapping relationship, acquiring storage position information of actual data mapping to the virtual LBA address space pointed by read/write requests, and completing I/O redirection. The system includes an establishment module, setting module, establishment and saving module, and redirection module. The invention enables data owners to master metadata generation method, preservation method and position, and LUN devices of user data not to be illegally mounted, thus guaranteeing security of user data.

### FIELD OF INVENTION

The invention relates to the field of data security technology, particularly to a method and system for improving the data security of cloud computing.

### BACKGROUND

Cloud computing transforms IT (Information Technology)resources into services (IT as a Service), which is delivered to end users by a pay-as-go business model, thereby greatly reducing the operating costs of IT, accelerating the delivery cycle of IT resources, and improving the operational efficiency. Cloud computing has promoted the concentration and sharing of IT resources; according to its deployment and service categories, cloud computing can be classified into private cloud computing, public cloud computing and hybrid cloud computing; due to different species of IT services provided, cloud computing can also be reflected in the following modes: Infrastructure as a Service (IaaS), Platform as a Service (PaaS), Software as a Service (SaaS) and Storage as a Service (cloud storage). Through cloud computing, although IT cost of users can be reduced, data security risks are also more centralized in cloud computing data center ends, reflected in following several aspects: 1) data isolation and security in the multi-tenant mode; in the public cloud computing data center in the multi-tenant mode, centralized data storage of multiple tenants, especially for the tenants who are competitors to one another will lead to certain security risks, and the private cloud computing data center also needs to provide effective data isolation for the data of all functional departments; 2) illegal invasion of hackers will result in leakage of important data; 3) human errors or ethical problems of cloud computing data center administrators, especially super administrators can result in the leakage of user data and so on.

At present, security solutions of cloud computing data can be classified into two categories:

One is to protect data security of users for the storage as a service (that is, cloud storage) through logical level of multi-tenant data isolation, relying on data encryption technology. The logical level of isolation is mainly achieved through the metadata information saved on the cloud computing data center end, such as Object Storage Device (OSD), typical implementations including EMC Atmos, Amazon S3 storage services; there are policy-based multi-tenant data security management methods and systems, such as the United States Patent US 2011/0022642 Policy Driven Cloud Storage Species Management and Cloud Storage Policy Router. In the case of logic level of isolation, though the data after different users log in are only the data authorized by them, in order to protect the security of data, users often need to encrypt the data before transmission to a cloud computing data center.

The other is for cloud computing modes beyond storage as a service, such as software as a service (SaaS), infrastructure as a service (IaaS), and platform as a service (PaaS). For these cloud computing modes, data security solutions of storage as a service are not applicable, because, storage as a service mostly is based on Restful protocol but not on SCSI protocol, with data object or document as a unit for data access, data security has a high priority (data usually needs for encryption), and the requirements for data access delay and I/O performance and reliability are low; for other cloud computing modes (that is SaaS, IaaS and PaaS), data access is mainly based on SCSI protocol, so data access delay, I/O performance and reliability, and data security also have the same and even higher priority; meanwhile, in order to guarantee data access to I/O performance, data cannot usually be encrypted, thereby making the data security of cloud computing tenants completely rely on professional observance of cloud computing service providers and their technology capacity for data security protection. For the cloud computing modes, the current solutions are mainly through physical isolation of multi-tenant data on the cloud computing data center ends combined with the Service Level Protocol (SLA) signed between cloud computing service providers and users for guarantee. The physical isolation of multi-tenant data is primarily implemented through the division of different LUN on the cloud computing data center ends. Each user is assigned with one or more exclusive physical LUN devices on the data center end, and the data are stored only on the physical LUN devices, thus enabling the physical isolation between different user data; a typical solution is Netapp MultiStore. Physical-level isolation can guarantee the performance and reliability of data access to a certain extent; however, taking into account it is very difficult to encrypt data on cloud computing ends in order to guarantee the performance, the resulting data security risks can be worried about surely by cloud computing tenants. Service contracts between the cloud computing service providers and tenants can reduce the above risks to some extent, but it cannot be avoided, and illegal invaders or cloud computing data center administrators can still mount the LUN devices where user data are saved to other hosts illegally, without authorization from data owners, thus to acquire the data.

In summary, the existing technologies of cloud computing data security solutions cannot address the data security issues of the cloud computing modes (especially IaaS, PaaS and SaaS) except for storage as a service, namely, while guaranteeing the security of data, the enterprise-class cloud computing requirements such as data access performance and reliability, can be met.

### SUMMARY OF THE INVENTION

In order to solve the problems, such as the existing cloud computing data security solutions not suitable for the cloud computing modes other than cloud storage, and being prone to illegal access, the invention provides a method for improving the data security of cloud computing, and the method comprises:

users establishing an index information table for physical LUN devices available to cloud computing service instances;

users establishing a virtual LUN device, and according to the index information table, setting mapping rules of virtual LBA address space for the virtual LUN device and LBA address space for actual data storage;

according to the mapping rules, users establishing and saving the mapping relationship between virtual LBA address space for data access to virtual LUN devices and LBA address space for actual data storage in a specified cloud computing data center;

according to the mapping relationship, acquiring the storage position information of actual data mapping to the virtual LBA address space pointed by external data read/write requests, and completing I/O redirection.

The content of the index information table includes global ID of LUN device, ID of cloud computing data center and local ID of LUN device; the cloud computing service instances include software as a service instance, infrastructure as a service instance, and platform as a service instance.

The virtual LUN devices are placed at user ends or the user trusted third-party clients.

The specific steps for establishing and saving the mapping relationship include:

selecting multiple virtual LBA addresses as a minimum segmentation unit of LBA address space and physical LBA address space;

according to the minimum segmentation unit, segmenting the virtual LBA address space and the physical LBA address space for data storage into a same number of virtual LBA address and physical LBA address extents;

according to the mapping rules, users mapping virtual LBA address extents to physical LBA address extents one by one, mapping virtual LBA addresses in each virtual LBA address extent to physical LBA addresses in each physical LBA address extent corresponding to the virtual LBA address extent one by one, and establishing and saving a mapping relationship between the virtual LBA address space and the physical LBA address space for data storage according to the above mapping results.

The multiple LBA addresses are continuous, discontinuous, regular or irregular LBA addresses.

According to the mapping relationship, acquiring the physical storage position of the data information mapping to the virtual LBA address space pointed by external data read/write requests, completing I/O redirection steps include the following:

according to the mapping relationship between the virtual LBA address space specific for external data read/write requests and the LBA address space for actual data storage in a specified cloud computing data center, querying and acquiring each LBA address of actual data storage mapping to each virtual LBA address in the virtual LBA address space;

according to global IDs of LUN device in the index information table, querying and acquiring the cloud computing data center and the LUN device local ID corresponding to each physical LBA address;

according to the cloud computing data center and the LUN device local ID corresponding to each physical LBA address, forwarding external data read/write requests to the physical LBA address for data storage, and completing data I/O request redirection. The method also includes: users updating the mapping relationship according to a preset frequency.

The invention also provides a system for improving the data security of cloud computing, including:

an establishment module used for users establishing an index information table for physical LUN devices available to cloud computing service instances;

a setting module used for users creating a virtual LUN device, and according to the index information table, setting mapping rules of virtual LBA address space for the virtual LUN device and LBA address space for actual data storage;

an establishment and saving module used for users establishing and saving a mapping relationship between virtual LBA address space for data access to LUN devices and LBA address space for actual data storage in a specified cloud computing data center according to the mapping rules;

a redirection module used for acquiring the storage position information of actual data mapping to the virtual LBA address space pointed by external data read/write requests and completing I/O redirection according to the mapping relationship.

The establishment and saving module includes:

a selection unit used for selecting multiple LBA addresses as a minimum segmentation unit of virtual LBA address space and physical LBA address space;

a segmentation unit used for segmenting the virtual LBA address space and physical LBA address space for data storage into a same number of virtual LBA addresses and physical LBA addresses extents according to the minimum segmentation unit;

a mapping relationship establishment unit used for mapping virtual LBA address extents to physical LBA address extents one by one, and mapping virtual LBA addresses in virtual LBA address extents to physical LBA addresses in physical LBA address extents one by one according to the mapping rules, and establishing and saving a mapping relationship between virtual LBA address space and physical LBA address space for data storage according to the mapping results above.

The redirection module includes:

a first acquisition unit used for querying and acquiring the LBA address of actual data storage corresponding to each virtual LBA address in the virtual LBA address space according to the corresponding relationship between virtual LBA address space pointed by external data read/write requests and LBA address space for actual data storage in a specified cloud computing data center;

a second acquisition unit used for querying and acquiring the cloud computing data center and the local ID of the LUN device corresponding to each physical LBA address according to global IDs of LUN device in the index information table;

a direction unit used for forwarding an external data read/write request to the physical LBA address space for actual data storage, and completing the redirection of data I/O requests according to the cloud computing data center and the local ID of the LUN device corresponding to each physical LBA address.

The system also includes an updating module, for updating the mapping relationship in accordance with a preset frequency.

This invention enables data owners to master the metadata generation method, preservation method and position information while achieving physical isolation of user data on cloud computing data center end, and the requirements of enterprise-level cloud computing service calculation for I/O performance and reliability are also met, so that even when the cloud computing data center suffers from illegal invasion, the physical LUN device of user data is not illegally mounted and user data is not leaked, thus guaranteeing the security of user data.

### BRIEF DESCRIPTION OF THE DRAWINGS

FIG. 1 is the mapping relationship from the virtual LBA address space in the embodiment of the invention to the physical LBA address space for data storage;

FIG. 2 is the access pattern embodiment 1 of a third-party cloud computing service to virtual LUN devices in the embodiment of the invention;

FIG. 3 is the access pattern embodiment 2 of a third-party cloud computing service to virtual LUN devices in the embodiment of the invention;

FIG. 4 is the flow chart of the method for improving the data security of cloud computing in the embodiment of the invention;

FIG. 5 is the architecture diagram of the system for improving the data security of cloud computing in the embodiment of the invention.

### DETAILED DESCRIPTION OF THE PRESENTLY PREFERRED EMBODIMENTS

In combination with the attached diagrams and embodiments in the following, the invention's technical solution is further described.

In order to better address data security issues of cloud computing, the embodiment of the invention provides a method for improving the data security of cloud computing; the specific steps of this method including, users creating and saving a mapping relationship between the virtual LBA address space for data access of cloud computing service instance to virtual LUN devices, and the physical LBA address space for data storage in a specified cloud computing data center on user end (or user trusted third party client); acquiring the storage position information of actual data mapping to the virtual LBA address space pointed by external data read/write requests according to the mapping relationship, and thus completing I/O redirection of user data access. Through the above method, users can achieve physical isolation of multi-tenant data on the cloud computing data center end; meanwhile in the case of data without encryption, if data owners do not authorize the mapping relationship information between the virtual LBA address space for I/O requests and the physical LBA address space for data storage in the specifies cloud computing data center, it is difficult to access illegally to the physical content of data, thus enhancing the security of user data significantly.

It's important to note that the cloud computing and cloud computing service instances in the embodiment of this invention only apply to cloud computing modes in addition to the storage as a service (or cloud storage), including software as a service (SaaS), infrastructure as a service (IaaS) and platform as a service (PaaS).

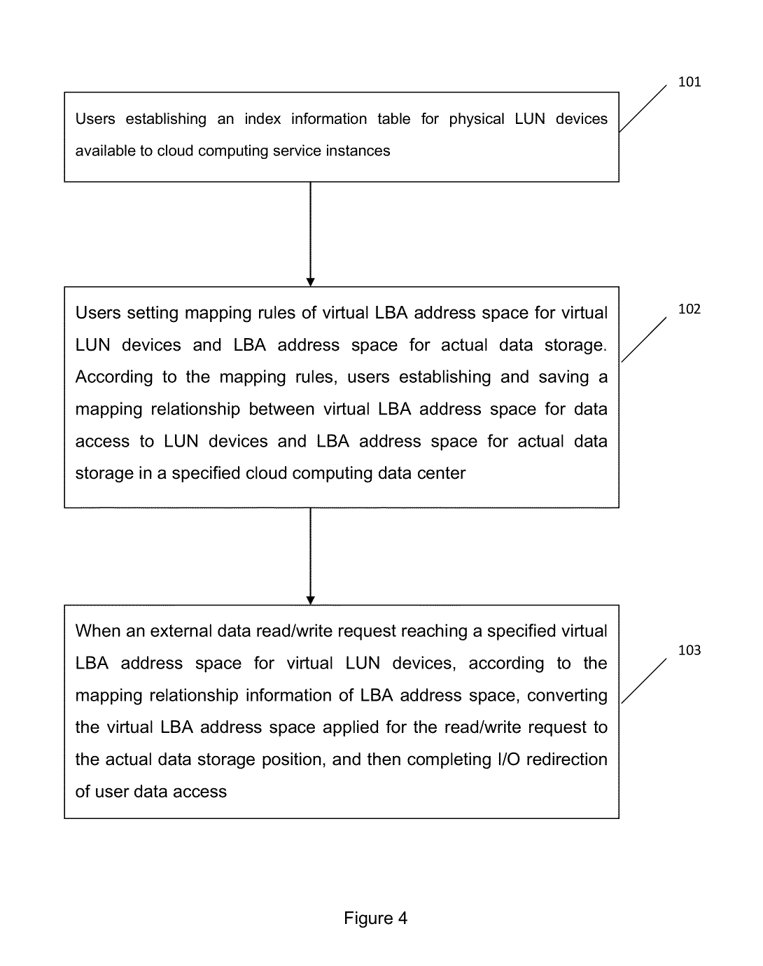

As shown in FIG. 4, the embodiment of the invention provides a method for improving the data security of cloud computing, including the following steps:

Step 101: users establishing an index information table for physical LUN devices available to cloud computing service instances.

First of all, users need to plan physical LUN devices used to store actual data for their own or rented cloud computing service instance. The physical LUN devices can be derived from cloud computing service providers (located in the specified cloud computing data centers) or from third-party storage service providers (to guarantee data access performance, they need to build a good network connection with cloud computing service providers), or from the local data centers of users. In the embodiments, third-party storage service provider can include storage-as-a-service providers (that is, cloud storage service providers), such as Amazon S3 storage service; it is important to note that most of the current public cloud storage services are accessed based on restful protocol with data object or document as a unit, but not accessed to data blocks based on SCSI protocol; to make the cloud computing service embodiment in the embodiment of this invention access to its data, protocol conversion is needed, that is, the restful protocol is converted into block based protocol, and this protocol conversion has been successfully practiced, typically including cloud storage products and solutions of StorSimple and TwinStrata. The concrete details will not be explained here.

Secondly, users need to establish an index information table of global physical LUN devices for the physical LUN devices used by cloud computing service instances, as shown in table 1. The index information table includes global ID of LUN device, ID of cloud computing data center and local ID of LUN device; of which, the global ID of LUN device is one of the main basis for establishing future mapping relationship between virtual LBA address space on virtual LUN devices and actual data storage position; meanwhile, the global ID of LUN device and the assigned ID of cloud computing data center are local variables, and their working scope is only limited to the virtual LUN devices of the users. For different users and even different virtual LUN devices of the same users (as described in the step 102 below), the information in the index information table can be different, for example: the ID of the same cloud computing data center can be assigned to 0 at the user A, and can be assigned to 1 at the user B and so on; this method of assignment is helpful for the protection for data privacy of data owners. In addition, considering data security, the index information table is usually saved on user end or a user-trusted third-party client.

TABLE 1

| Global ID of LUN | ID of the assigned cloud | |
|---|---|---|
| device | computing data center | Local ID of LUN device |
| 00 | 0 | 0 |
| 01 | 0 | 1 |
| 14 | 1 | 4 |
| 25 | 2 | 5 |
| . . . | . . . | . . . |

In the Table 1, the global ID of LUN device refers to the only identifier used in the process of establishing a mapping relationship of LBA address space for LUN devices on cloud computing data center end, corresponding to the ID of cloud computing data center where it belongs (can be the data center of cloud computing service provider, or third party cloud storage service provider, or local data center of users) and the local ID of the LUN devices on the cloud computing data center end. The local ID of LUN device refers to the only identifier of the LUN device assigned in the specified cloud computing data center, such as the specified LUN unit number in a specified storage pool. What needs to be pointed out is that LUN devices on the cloud computing data center end can have different implementation modes, and they can be real LUN devices, or virtual LUN devices achieved through virtual storage technology, or LUN devices shown to cloud computing service embodiment after storage space provided by a third party cloud storage service provider is converted by restful to SCSI protocol, but regardless of which kind of implementation modes, physical LUN devices for data storage are shown out, with no effect on the implementation steps of the embodiment of the invention.

Step 102: users establishing a virtual LUN device, and setting mapping rules of virtual LBA address space for virtual LUN devices and physical LBA address space for actual data storage according to the index information table of global physical LUN devices; according to the mapping rules, users establishing and saving the mapping relationship between virtual LBA address space for actual data access to LUN devices and LBA address space for actual data storage in a specified cloud computing data center.

Users need to establish a virtual LUN device for the data access of cloud computing service instances. The virtual LUN device can be placed on the user end or user-trusted third-party client (if the cloud computing service providers get access to the user's authorization, the cloud computing service provider can be used as a third-party client).

In order to protect the data security, users in accordance with their actual requirements for data security, set the mapping rules of LBA address space, and the mapping rules of LBA address space can be manually set or set by a mapping rule setting engine of LBA address space. Specifically, in the process of establishing the mapping relationship of LBA address space, users can customize and select mapping rules according to the security requirements for saving data on the virtual LUN devices, for example: regular operation rules can be used as the mapping rules for the data with lower security requirements, namely: after the set of physical LBA addresses (that is, a collection composed of all physical LBA addresses selectable) is established, the i-th virtual LBA address corresponds to the physical LBA address of the set of physical LBA addresses ranked on the (i+1)th position and so on; for the data with high security requirements, the mapping rules for LBA address space and the conversion rules for data access protocols need to be enabled only, and it is hard for them to be cracked. In extreme cases, in order to maximize the security of metadata, the true random mapping rules of virtual LBA address and actual data storage LBA address can be used, and the two can match. A method is listed in the following to demonstrate the feasibility of this method of true random mapping rules.

Assuming there are n virtual LBA addresses on a virtual LUN device, they need to correspond to n actual data storage LBA addresses on multiple cloud computing data centers, then

Step 1.1, set i=1 (I is a natural number, i<=n), and generate a truly random number Ri;

Step 1.2, sort all the remaining physical LBA addresses randomly, and generate a set of physical LBA addresses with the length of (n+1−i), namely, IbaSet;

Step 1.3, correspond to the physical LBA address of the i-th virtual LBA address, through the following operations:

Xi=Ri mod(n+1−i) (where mod is the modulo operation)

Get the Xi-th physical LBA address from the IbaSet;

Step 1.4, set i=i+1, repeat steps 1.1 to 1.3, and loop until i=n, and all virtual LBA addresses correspond to the physical LBA address.

It's important to note that the method for generating true random numbers in step 1.1 has been very mature, and the Applied Cryptography Protocols, Algorithms and C Source Code issued by the Machinery Industry Press, the method for generating true random numbers given in page 301 can be used in the concrete implementation; for instance, true random numbers are generated by use of random noise, computer clock, CPU load or times of network packet arrivals.

After the mapping rules of LBA address space are established, the mapping relationship between virtual LBA address space and physical LBA address space for data storage on the cloud computing data center needs to be set up. It's important to note that the physical LBA address space for data storage on the cloud computing data center may be from multiple physical LUN devices of multiple cloud computing data centers, and such cloud computing data centers are not limited to the local data centers of cloud computing service providers or the data centers of remote third-party cloud computing service providers.

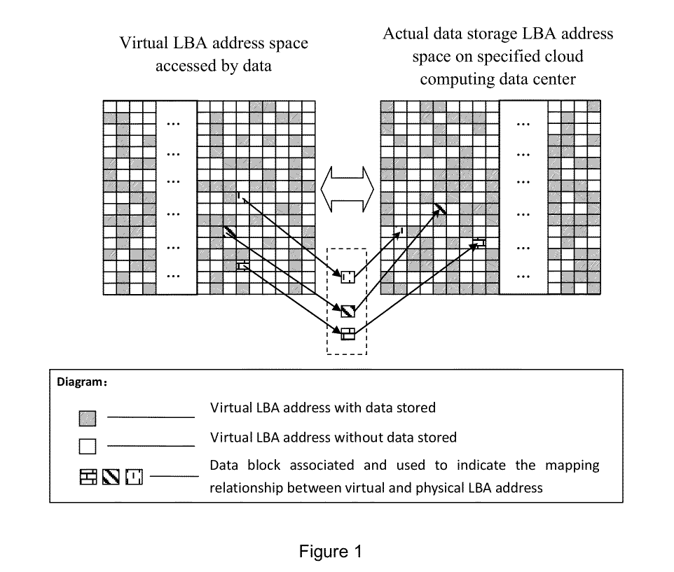

FIG. 1 shows the mapping relationship between the virtual LBA address space for the virtual LUN devices accessed by the cloud computing service instances and the physical LBA address space for data storage on the cloud computing data center after the mapping rules of LBA address space are set up.

TABLE 2

| Virtual LBA address of virtual LUN | Corresponding actual data storage |
|---|---|
| device end (ID of virtual LUN | LBA address (Global ID of LUN |
| device:virtual LBA address) | device:physical LBA address) |
| . . . | . . . |
| 1:32 | 00:48 |
| . . . | . . . |
| 1:49 | 25:94 |

Table 2 shows the mapping relationship information of virtual LUN address space for virtual LBA devices accessed by cloud computing service instances and the physical LBA address space for data storage in the specified cloud computing data center, and the mapping relationship information in the embodiment of this invention is known as metadata information. In specific applications, the metadata information can be chosen and saved on user end or the user-trusted third-party client.

It's important to note that the mapping relationship information of virtual LUN address space for virtual LBA devices and physical LBA address space for data storage (or metadata information) may occupy a different storage space due to a variety of mapping rules for users; the following method can be used to create and save metadata information if aiming to reduce the amount of metadata information so as to achieve the purpose of saving storage space and improving the performance:

Select multiple LBA addresses (continuous LBA addresses, such as 0x00000000 0x00000001, 0x00000002, and 0x00000003; or regular discontinuous LBA addresses, such as: 0x00000000, 0x0000000A, 0x00000014, and 0x0000001E; or irregular, discontinuous random LBA addresses) as a minimum segmentation unit of virtual LBA address space and physical LBA address space; segment the virtual LBA address space and physical LBA address space for data storage into a same number of virtual LBA address and physical LBA address extents according to the minimum segmentation unit; users correspond the virtual LBA address extents to physical LBA address extents one by one, and correspond virtual LBA addresses in the virtual LBA address extents to physical LBA addresses in the physical LBA address extents one by one according to the mapping rules, and establish and save the mapping relationship between virtual LBA address space and physical LBA address space for data storage according to the mapping results above. Step 103, when an external data write/read request reaches the virtual LBA address space specified by virtual LUN devices, according to the mapping relationship information of the LBA address space, convert the virtual LBA address space applied for by the request to the actual data storage position, and then complete the I/O redirection of data access.

After the step 102 is completed, the mapping relationship between virtual LBA address space for virtual LUN devices and physical LBA address space for data storage in the specified cloud computing data center is built up, and then all the read/write I/O requests that reach the specified virtual LBA address space for virtual LUN devices can be redirected to their mapping physical LBA address space for data storage.

In particular, assuming that a read/write I/O request reaches the virtual LUN device, the I/O redirection needs to be completed through the following steps:

Step 2.1, an external (read or write) I/O request reaches the specified virtual LBA address space of the virtual LUN device, and the LBA address space contains at least a virtual LBA address;

Step 2.2, according to the established mapping information table (Table 2) of the LBA address space, query and acquire the physical LBA address for data storage mapping to each virtual LBA address in the virtual LBA address space;

Step 2.3, according to the index information table (table 1) of the global physical LUN device of the cloud computing data center end, and the global ID information of LUN device mapping to each physical LBA address acquired in step 2.2, query and acquire the ID of the cloud computing data center and the local ID of LUN device mapping to each physical LBA address;

Step 2.4, according to the ID of cloud computing data center and local ID of LUN device mapping to each physical LBA address acquired in steps 2.2 and 2.3, forward the I/O request to the physical LBA address for data storage acquired in step 2.2, and thus complete the redirection of data I/O request.

It's important to note that the initiators of I/O requests reaching the virtual LUN devices can be end users; or non-cloud computing service embodiments, such as local or remote application instances; also local (that is, private cloud service) or remote public cloud computing service instances. Because the feasibility of the embodiment of the invention depends on how to deal with the I/O requests reaching the virtual LUN devices, which has nothing to do with the I/O requests, the feasibility of the invention is here further discussed just with the example of local or remote cloud computing service embodiment launching I/O requests.

In addition, in step 2.4 above, if a third-party public cloud storage service is used, the redirection of data I/O requests can be completed still through third party public cloud storage identity authentication, billing and other processes.

In the embodiment of the invention, the local or remote cloud computing service instances include cloud computing service instances in the modes of SaaS (Software as a Service), IaaS (Infrastructure as a Service) and PaaS (Platform as a Service). Local cloud computing service embodiments exist in internal controllable private network (intranet), namely, private cloud computing services, while remote cloud computing service embodiments exist in external uncontrollable public network (Internet), that is, public cloud computing services.

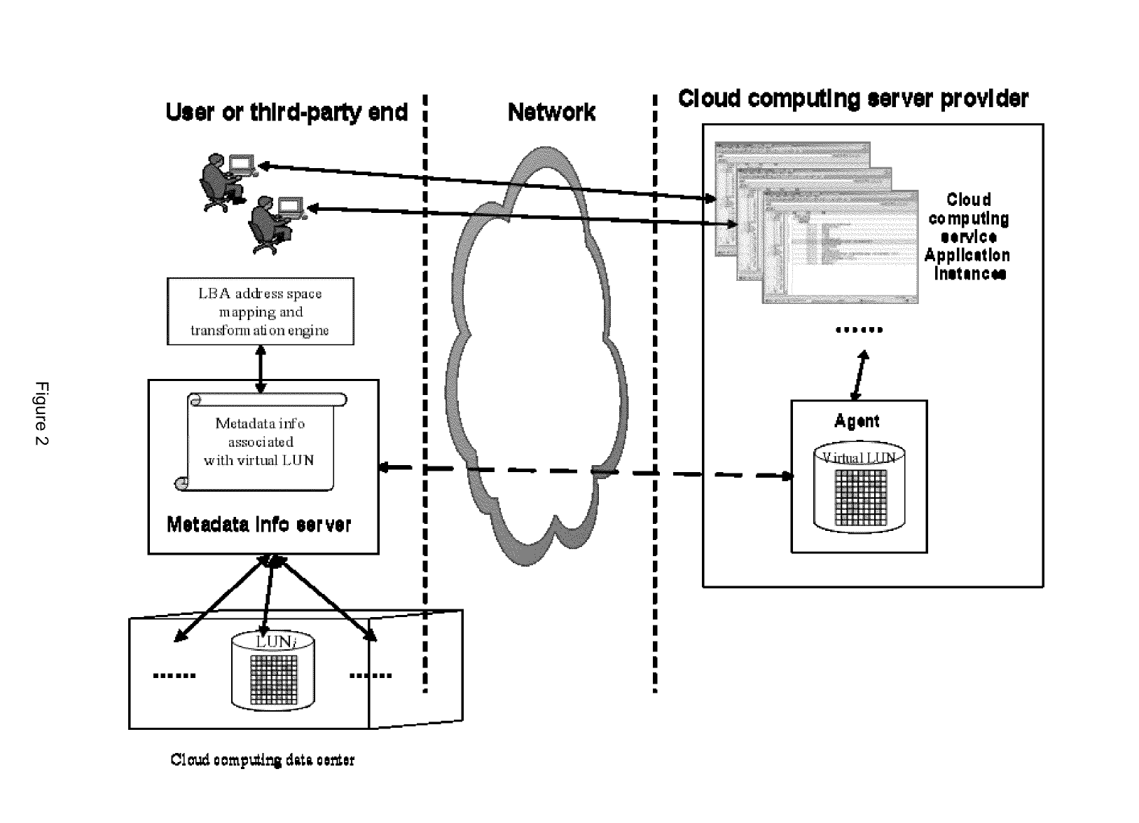

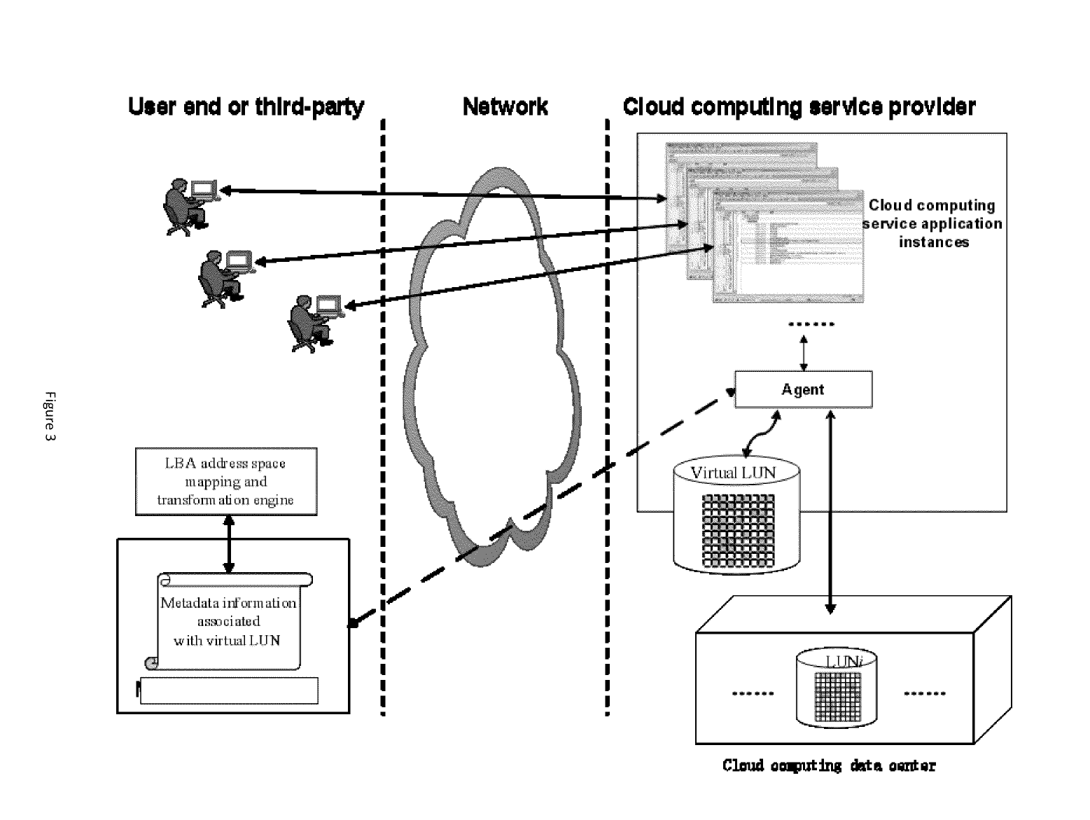

For the embodiment of this invention, the access to virtual LUN devices has two species of typical topology structures: 1) in-band architecture, which unifies the access path of data and metadata, that is, data stream and control stream are transmitted on the same line, as shown in FIG. 2; 2) out-of-band architecture, which separates the access path of data and metadata, that is, data stream and control stream are transmitted on different lines separately, as shown in FIG. 3. Users can make a selection according to the security of data access and performance requirements of data access.

In the embodiment of this invention, regardless of which topology structure, an agent program needs to be built in the cloud computing service instance end, and it can make the created virtual LUN devices visible to cloud computing service instances, so that the access of cloud computing service instances to data is transparent, while the agent program can also real-time access metadata information server to acquire the metadata information mapping to each virtual LBA address, and can also forward the I/O requests received by virtual LUN devices to the physical LBA address space for data storage. The implementation process of data read/write I/O redirection is described separately under two topology structures.

1. In-Band Architecture, as Shown in FIG. 2:

Step 3.1, after virtual LUN is mounted by the agent program, the read/write I/O request of cloud computing service instance reaches a specified virtual LBA address space of the virtual LUN devices (if it is a write I/O request, the request should also contain the data to be written), and the LBA address space contains at least a virtual LBA address; Step 3.2, the agent program forwards the I/O request of the virtual LBA address space reaching the virtual LUN to the metadata information server on the user end (or user-trusted third-party client);

Steps 3.3, the metadata information server on the user end (or user-trusted third-party client) acquires the set of actual data storage LBA addresses mapping to the virtual LBA address space; further transmits the data read/write I/O requests to the physical LBA address space for data storage in the specified cloud computing data center and completes I/O re-direction according to the acquired data access to physical LBA address space information, and returns the data read/write results through the agent program to the cloud computing service instance (if it's read I/O, the read data needs to be all returned to the cloud computing service instance).

The cloud computing data center in Step 3.3 can be a data center managed by the cloud computing service provider end, or a local data center of users, or a data center of other storage service providers (such as cloud storage service providers).

2. Out-of-Band Architecture, as Shown in FIG. 3:

Step 4.1, after virtual LUN is mounted by the agent program, the read/write I/O request of third-party cloud service reaches the specified virtual LBA address space of the virtual LUN device, and the LBA address space contains at least one virtual LBA address;

Step 4.2, the agent program associated with the virtual LUN device accesses the metadata information server on the user end (or user-trusted third-party client) to acquire the set of actual data storage LBA addresses mapping to the virtual LBA address space;
Step 4.3, on the basis of the data access to the actual LBA address space information acquired in Step 4.2, the agent program associated with the virtual LUN device transmits the data read/write I/O requests received by the virtual LUN device to the physical LBA address space for data storage in the specified cloud computing data center, completes I/O re-direction, and returns the data read/write results to the cloud computing service instance (if it is a read I/O, the read data needs to be all returned to the cloud computing service instance).

If the cloud computing data center in the above embodiment (including in-band architecture and out-of-band architecture) is not the data center managed by cloud computing service provider end or a local data center of users, that is, the data center of other cloud computing service providers (such as cloud storage service providers), so it is also necessary to access the data center prior to steps 3.3 and 4.3 according to the saved data service access settings (such as authentication and billing).

In addition, in the out-of-band architecture, the information of cloud computing service instance interacting with virtual LUN devices is mainly metadata information; due to its smaller data size, it has better performance relative to the in-band architecture. In order to further enhance the security, for either in-band architecture or out-band architecture, users can update the metadata information of virtual LUN devices in accordance with the preset frequency (valid only for LBA address that is not read-write). In extreme cases, users can transform the mapping rules and update the metadata information once after access the metadata information.

It's important to note that in the embodiment of the invention above, the virtual LUN device accessed by cloud computing service instance is placed on the cloud computing service provider end; as mentioned above, if the data access network speed from the cloud computing service instance end to user ends can meet the performance requirements (such as 8 Gbps optical fibre or 10-gigabit Ethernet), or for the sake of data security users are willing to sacrifice part of data access performance and reliability and any other requirements, the virtual LUN device can also be placed on the user end. In view of basically the same implementation modes, it will not be explained in detail here.

All in all, access objects of virtual LUN devices are terminal users, or local or remote instances (non-cloud computing service instances), or local or remote cloud computing service instance; in the access mode of cloud computing service instance, regardless of virtual LUN devices placed on user ends or third party cloud computing service ends, where the implementation mode of data read/write I/O re-direction achieved mode is in-band architecture or out-of-band architecture, the embodiment of this invention is feasible.

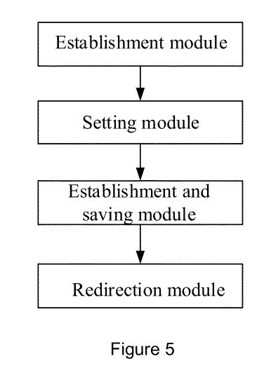

See FIG. 5, the embodiment of the invention also provides a system for improving the data security of cloud computing, including:

an establishment module used for users establishing an index information table for physical LUN devices available to cloud computing service instances;

a setting module used for users creating a virtual LUN device, and according to the index information table, setting mapping rules of virtual LBA address space for the virtual LUN device and LBA address space for actual data storage;

an establishment and saving module used for users establishing and saving a mapping relationship between virtual LBA address space for data access to LUN devices and LBA address space for actual data storage in a specified cloud computing data center according to the mapping rules;

a redirection module used for acquiring the storage position information of actual data mapping to the virtual LBA address space pointed by external data read/write requests and completing I/O redirection according to the mapping relationship.

In this embodiment, the establishment and saving module includes:

a selection unit used for selecting multiple LBA addresses as a minimum segmentation unit of virtual LBA address space and physical LBA address space;

a segmentation unit used for segmenting the virtual LBA address space and physical LBA address space for data storage into a same number of virtual LBA addresses and physical LBA addresses extents according to the minimum segmentation unit;

a mapping relationship establishment unit used for mapping virtual LBA address extents to physical LBA address extents one by one, and mapping virtual LBA addresses in virtual LBA address extents to physical LBA addresses in physical LBA address extents one by one according to the mapping rules, and establishing and saving a mapping relationship between virtual LBA address space and physical LBA address space for data storage according to the mapping results above.

In this embodiment, the redirection module includes:

a first acquisition unit used for querying and acquiring the LBA address of actual data storage corresponding to each virtual LBA address in the virtual LBA address space according to the corresponding relationship between virtual LBA address space pointed by external data read/write requests and LBA address space for actual data storage in a specified cloud computing data center;

a second acquisition unit used for querying and acquiring the cloud computing data center and the local ID of the LUN device corresponding to each physical LBA address according to global IDs of LUN device in the index information table; a direction unit used for forwarding an external data read/write request to the physical LBA address space for actual data storage, and completing the redirection of data I/O requests according to the cloud computing data center and the local ID of the LUN device corresponding to each physical LBA address.

The system for improving the data security of cloud computing in this embodiment also includes an updating module for updating the mapping frequency in accordance with a preset frequency.

The method and system in the embodiment of the invention is different from the method and system described in the U.S. Pat. No. 7,171,453 Virtual Private Volume Method and the System. In this United States Patent, the privacy of storage service user (consumer) and provider is protected through saving a LUN mapping relationship table on the middle layer, that is, both sides are mutually invisible, and it is not used to solve the problem of data security in cloud computing, different from the technical solution in the embodiment of the invention.

There is a clear distinction between the method for improving the data security of cloud computing provided in the embodiment of the invention and the traditional method for storage virtualization. The embodiment of the invention is intended to address the problem of data security on cloud computing data center ends under the precondition there is no trust relationship (in particular, public cloud computing data center) between consumers (users) using storage services and storage service providers. Data access and transmission may be in a public networking environment vulnerable to unlawful attacks (public cloud computing service), and the mapping relationship information of LBA addresses between the virtual LUN devices and physical LUN devices on the cloud computing data center is generated by end user by the specified method and saved into the user-specified position. By means of the traditional method for storage virtualization, users cannot intervene with and save the mapping relationship information of LBA addresses between the virtual LUN devices and physical LUN devices on user ends in a mutually trusted private network environment; just because of this, based on traditional storage virtualization technologies, regardless of host based storage virtualization, also switch based storage virtualization, or storage device based storage virtualization, the created virtual LUN devices can be mounted (illegally) to different hosts to access the data on them. Compared with the existing data security solutions on cloud computing data centers, the method for improving the data security of cloud computing provided in the embodiment of the invention has the following advantages:

1. While physical level of isolation of user data is achieved in cloud computing data center ends, data owners can master the generation method, preservation method and position (local or trusted third party client) of metadata (namely, the mapping relationship information of LBA addresses between the virtual LUN devices and physical LUN devices on cloud computing data center ends), so that even when the cloud computing data center suffers from illegal invasion, the physical LUN device of user data is not illegally mounted and user data is not leaked, thus guaranteeing the security of user data.

2. In the case of metadata generated by a true random method, even if the LUN device mapping to user is illegally mounted on the cloud computing data center end, its content cannot be obtained, thus ensuring the security of user data.

In practical applications, various functional modules and units involved in the embodiment can be implemented by computer programs that run on the computer hardware, and the programs can be stored in computer-readable storage media; the programs in the process of execution can include the processes of embodiments for these methods above. Of which, the hardware is a server or desktop computer, notebook computer and so on containing one or more processors and storage media, and the storage media can be floppy disk, compact disc, read-only memory (ROM), or random access memory (RAM); the computer programs can be implemented by computer languages, not limited to C and C++.

The above is only a good embodiment of the invention and is not used to limit the invention; within the spirit and principles of the invention, any changes, equivalent replacement, improvements and so on shall be included in the scope of protection of the invention.

1. A method for improving data security of cloud computing comprising:
users establishing an index information table for physical LUN devices available to cloud computing service instances;
users establishing a virtual LUN device, and according to the index information table, setting mapping rules of virtual LBA address space for the virtual LUN device and LBA address space for actual data storage;
according to the mapping rules, users establishing and saving the mapping relationship between virtual LBA address space for data access to virtual LUN devices and LBA address space for actual data storage in a specified cloud computing data center; and
according to the mapping relationship, acquiring the storage position information of actual data mapping to the virtual LBA address space pointed by external data read/write requests, and completing I/O redirection.

2. The method of claim 1 wherein the index information table including global ID of LUN device, ID of cloud computing data center and local ID of LUN device; the cloud computing service instances including software as a service instance, infrastructure as a service instance, and platform as a service instance.

3. The method of claim 2 wherein the virtual LUN devices are placed at user ends or the user trusted third-party clients.

4. The method of claim 3 wherein the specific steps for establishing and saving the mapping relationship comprise:
selecting multiple virtual LBA addresses as a minimum segmentation unit of LBA address space and physical LBA address space;
according to the minimum segmentation unit, segmenting the virtual LBA address space and the physical LBA address space for data storage into a same number of virtual LBA address and physical LBA address extents;
according to the mapping rules, users mapping virtual LBA address extents to physical LBA address extents one by one, mapping virtual LBA addresses in each virtual LBA address extent to physical LBA addresses in each physical LBA address extent corresponding to the virtual LBA address extent one by one, and establishing and saving a mapping relationship between the virtual LBA address space and the physical LBA address space for data storage according to the above mapping results.

5. The method of claim 4 wherein the multiple LBA addresses are continuous, discontinuous, regular or irregular LBA addresses.

6. The method of claim 5 wherein according to the mapping relationship, acquiring the storage position information of actual data mapping to the virtual LBA address space pointed by external data read/write requests, and the specific steps for completing I/O redirection comprise:
according to the mapping relationship between the virtual LBA address space specific for external data read/write requests and the LBA address space for actual data storage in a specified cloud computing data center, querying and acquiring each LBA address of actual data storage mapping to each virtual LBA address in the virtual LBA address space;
according to global IDs of LUN device in the index information table, querying and acquiring the cloud computing data center and the LUN device local ID corresponding to each physical LBA address;
according to the cloud computing data center and the LUN device local ID corresponding to each physical LBA address, forwarding external data read/write requests to the physical LBA address for data storage, and completing data I/O request redirection.

7. The method of claim 6 wherein the method comprises users updating the mapping relationship in accordance with a preset frequency.

8. A system for improving the data security of cloud computing comprising:
an establishment module used for users establishing an index information table for physical LUN devices available to cloud computing service instances;
a setting module used for users creating a virtual LUN device, and according to the index information table, setting mapping rules of virtual LBA address space for the virtual LUN device and LBA address space for actual data storage;
an establishment and saving module used for users establishing and saving a mapping relationship between virtual LBA address space for data access to LUN devices and LBA address space for actual data storage in a specified cloud computing data center according to the mapping rules;
a redirection module used for acquiring the storage position information of actual data mapping to the virtual LBA address space pointed by external data read/write requests and completing I/O redirection according to the mapping relationship.

9. The system of claim 8 wherein the establishment and saving module comprises:
a selection unit used for selecting multiple LBA addresses as a minimum segmentation unit of virtual LBA address space and physical LBA address space;
a segmentation unit used for segmenting the virtual LBA address space and physical LBA address space for data storage into a same number of virtual LBA addresses and physical LBA addresses extents according to the minimum segmentation unit; and
a mapping relationship establishment unit used for mapping virtual LBA address extents to physical LBA address extents one by one, and mapping virtual LBA addresses in virtual LBA address extents to physical LBA addresses in physical LBA address extents one by one according to the mapping rules, and establishing and saving a mapping relationship between virtual LBA address space and physical LBA address space for data storage according to the mapping results above.

10. The system of claim 9 wherein the redirection module comprises:
a first acquisition unit used for querying and acquiring the LBA address of actual data storage corresponding to each virtual LBA address in the virtual LBA address space according to the corresponding relationship between virtual LBA address space pointed by external data read/write requests and LBA address space for actual data storage in a specified cloud computing data center;
a second acquisition unit used for querying and acquiring the cloud computing data center and the local ID of the LUN device corresponding to each physical LBA address according to global IDs of LUN device in the index information table; and
a direction unit used for forwarding an external data read/write request to the physical LBA address space for actual data storage, and completing the redirection of data I/O requests according to the cloud computing data center and the local ID of the LUN device corresponding to each physical LBA address.

11. The system of claim 10 further comprising an updating module used for updating the mapping relationship in accordance with a preset frequency.
